(19) United States
(12) Patent Application Publication
(10) Pub. No.: US 2012/0049623 A1
(43) Pub. Date: Mar. 1, 2012

(54) IMAGE FORMING APPARATUS AND METHOD OF CONTROLLING THE SAME

(75) Inventor: Yasunori NAKAYAMA, Toyokawa-shi (JP)

(73) Assignee: Konica Minolta Business Technologies, Inc., Tokyo (JP)

(21) Appl. No.: 13/221,367

(22) Filed: Aug. 30, 2011

(30) Foreign Application Priority Data
Aug. 31, 2010 (JP) 2010-193496

(51) Int. Cl. H02J 4/00

(52) U.S. Cl. 307/26

(57) ABSTRACT

An image forming apparatus includes a plurality of toner carriers, a plurality of charging members, a common alternating-current power source, a plurality of individual direct-current power sources, and a controller. The charging members are configured to charge the respective toner carriers. The common alternating-current power source is configured to apply an alternating-current voltage to the charging members. The individual direct-current power sources are configured to apply a direct-current voltage overlapping with the alternating-current voltage to a corresponding charging member. The individual direct current sensors are each configured to sense an amount of a direct current flowing into a corresponding individual direct-current power source among the individual direct-current power sources when an output of the alternating-current power source changes. The controller is configured to set the output of the alternating-current power source based on a result of sensing by an individual direct current sensor.

### CROSS-REFERENCE TO RELATED APPLICATIONS

The present application claims priority under 35 U.S.C. §119 to Japanese Patent Application No. 2010-193496, filed Aug. 31, 2010. The contents of this application are herein incorporated by reference in their entirety.

### BACKGROUND OF THE INVENTION

1. Field of the Invention

The present invention relates to an image forming apparatus and a method for controlling the image forming apparatus.

2. Discussion of the Background Art

Some of electrophotographic image forming apparatuses use toner. A toner image is first-transferred to a toner carrier at an image processing unit. The toner carrier is then brought into contact with a sheet of recording medium conveyed in a predetermined direction to second-transfer the toner image to the sheet. The image transferred to the sheet is then fixed at a fixing unit.

A color image forming apparatus generally uses an intermediate transfer belt as a toner carrier. While the intermediate transfer belt makes a circumferential movement, toner images of yellow, magenta, cyan, and black are first-transferred to the surface of the intermediate transfer belt from respective image forming units. The image forming units each include a photosensitive drum that is to be uniformly charged on the surface. A latent image on the surface of the photosensitive drum is developed into a toner image, which is then transferred to the intermediate transfer belt from the photosensitive drum.

Examples of the method of charging the photosensitive drum include non-contact types utilizing corona discharge and contact types using charging rollers, charging blades, and other charging means. The corona discharge methods cause various problems including significantly high voltages, ozone tendency, and high costs. In view of this, contact types using charging rollers are dominant in recent years.

Examples of the method of charging the charging rollers include direct-current charging by which the charging rollers are applied direct-current voltage from a direct-current power source, and alternating-current charging by which the charging rollers are applied discharge that alternates between positive and negative. Use of direct-current charging alone causes problems including poor uniformity of charging of the photosensitive drum, while use of alternating-current charging alone causes problems including tendency toward degradation of the film of the photosensitive drum due to an increase in the amount of discharge, and image deletion caused by the discharge. In view of this, it is common practice to apply direct-current voltage overlapping with alternating-current voltage to the charging rollers so as to adjust the output of the alternating-current power source and ensure a minimum application output.

Japanese Unexamined Patent Application Publication No. 2006-220955 discloses a configuration related to application of alternating-current voltage to a plurality of charging rollers using a common alternating-current power source. Specifically, a common alternating-current power source applies alternating-current voltage to a group of image forming units for three colors, namely, yellow, magenta, and cyan, and to a black-dedicated image forming unit. The application of alternating-current voltage is switchable between application to all of the image forming units and application only to the black-dedicated image forming unit (see, in particular, FIG. 3). This configuration eliminates the need for providing an alternating-current power source individually to each of the image forming units, resulting in an advantageously simplified structure.

The contents of Japanese Unexamined Patent Application Publication No. 2006-220955 are herein incorporated by reference in their entirety.

Incidentally, the same amount of current flows through the three color image forming units recited in Japanese Unexamined Patent Application Publication No. 2006-220955. In this respect, the components of the image forming units such as charging rollers may not necessarily have the same electrical properties; these may slightly differ from each other due to variations during production and wear through use. Thus, with the configuration recited in Japanese Unexamined Patent Application Publication No. 2006-220955, a suitable value of alternating-current voltage may not be applied to each of the image forming units.

Additionally, to consider the variation of current flowing through the image forming units in Japanese Unexamined Patent Application Publication No. 2006-220955, the application output of the alternating-current power source may presumably be set comparatively high, as conventionally practiced, so as to maintain a predetermined voltage at the image forming units. This allows more current than necessary to flow through some of the image forming units, which may cause increased consumption of power, wear of the photosensitive drum, and adverse effects associated with the discharge. However, setting the application output of the alternating-current power source comparatively low may possibly lead to an unclear image due to voltage deficiency.

Further, the amount of current (resistance) flowing through the individual image forming units may possibly change due to a change in load on the downstream side. In this respect, Japanese Unexamined Patent Application Publication No. 2006-220955 cannot accommodate to changes in the amount of current caused by change in load, which is another problem with the patent document.

### SUMMARY OF THE INVENTION

According to one aspect of the present invention, an image forming apparatus includes a plurality of toner carriers, a plurality of charging members, a common alternating-current power source, a plurality of individual direct-current power sources, and a controller. The plurality of charging members are configured to charge the respective toner carriers. The common alternating-current power source is configured to apply an alternating-current voltage to the plurality of charging members. The plurality of individual direct-current power sources are configured to apply a direct-current voltage overlapping with the alternating-current voltage to a corresponding charging member among the plurality of charging members. The plurality of individual direct current sensors are each configured to sense an amount of a direct current flowing into a corresponding individual direct-current power source among the plurality of individual direct-current power sources when an output of the alternating-current power source changes. The controller is configured to set the output of the alternating-current power source based on a result of sensing by an individual direct current sensor among the plurality of individual direct current sensors.

According to another aspect of the present invention, a method for controlling an image forming apparatus includes applying an alternating-current voltage to a plurality of charging members using a common alternating-current power source. The plurality of charging members are configured to charge respective toner carriers. A direct-current voltage overlapping with the alternating-current voltage is applied to each of the plurality of charging members using a plurality of individual direct-current power sources. Amounts of direct currents flowing into the plurality of individual direct-current power sources are sensed. An output of the alternating-current power source is set based on a result of sensing of an amount of a direct current among the direct currents.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic cross-sectional view of a printer according to the image forming apparatus of an embodiment;

FIG. 2 is a functional block diagram;

FIG. 3 is a graph showing a characteristic of each of image forming units; and

FIG. 4 is a flowchart of a control procedure.

### DESCRIPTION OF THE EMBODIMENTS

The embodiments will now be described with reference to the accompanying drawings, wherein like reference numerals designate corresponding or identical elements throughout the various drawings.

As used herein, the term “image forming apparatus” encompasses various machines, apparatuses, and appliances with printing functions. Examples include, but not limited to, monofunctional machines with printing functions such as copiers, printers, and facsimiles, and multifunctional machines with printing, scanning, communication, and other functions.

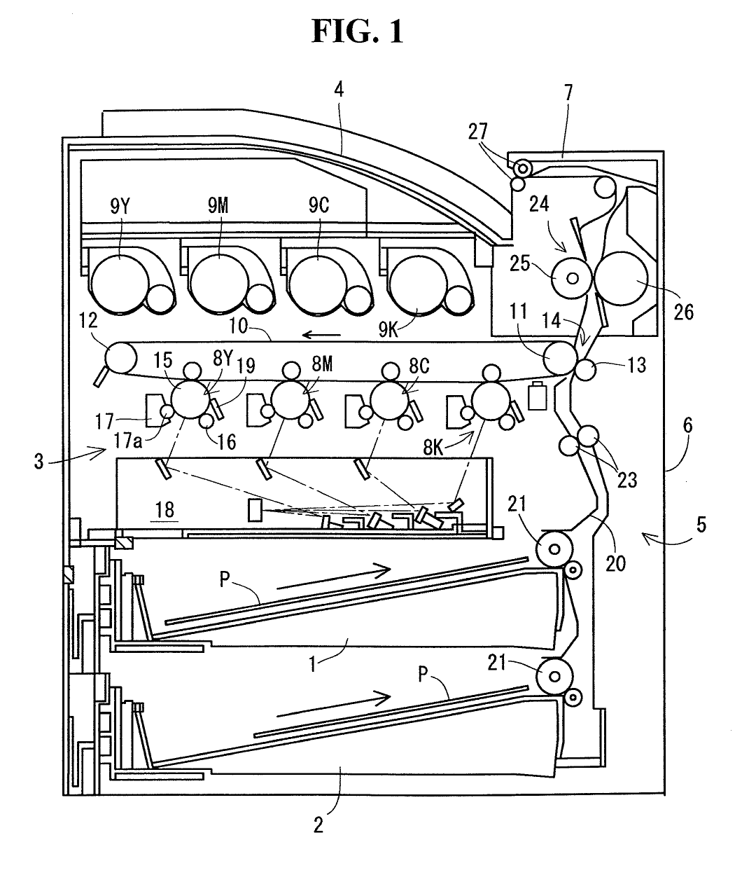

The embodiment of the present invention is applied to a printer. First, an overview of the printer will be described by referring to FIG. 1.

### (1) Overview of a Printer

As shown in FIG. 1, a printer includes two-stage feeding cassettes 1 and 2, an image processing unit 3 disposed above the feeding cassettes 1 and 2, a collection tray 4 disposed above the image processing unit 3, and a conveyer path (feeding unit) 5 through which sheets of paper P are conveyed from the feeding cassettes 1 and 2 toward the collection tray 4. The collection tray 4 is exposed on the top surface of a housing 6 that defines the exterior of the printer. An operation unit 7 is also disposed on the top surface of the housing 6.

The printer is full color-enabled. Specifically, the image processing unit 3 includes four image forming units 8Y, 8M, 8C, and 8K respectively corresponding to yellow Y, magenta M, cyan C, and black K; and four toner storage units 9Y, 9M, 9C, and 9K that correspond to the respective four colors. The four image forming units 8Y, 8M, 8C, and 8K are arranged with the yellow image forming unit 8Y farthest from the conveyer path 5 and the black image forming unit 8K closest to the conveyer path 5. A toner image is first-transferred from the image forming units 8Y, 8M, 8C, and 8K to an intermediate transfer belt 10.

The intermediate transfer belt 10 is looped across a drive roller 11 disposed adjacent to the conveyer path 5 and an idler roller 12 disposed further outward than the yellow image forming unit 8Y. The toner image carried on the intermediate transfer belt 10 is second-transferred to a sheet of paper P. The sheet of paper P is pressed against the intermediate transfer belt 10 by a second-transfer roller 13.

The image forming units 8Y, 8M, 8C, and 8K each include a photosensitive drum 15, a charging roller (charging member) 16, and a developer 17. The charging roller 16 uniformly charges the surface of the photosensitive drum 15. The photosensitive drum 15 has a charged layer that is irradiated with laser light by an exposure unit 18 based on an image signal to form an electrostatic latent image onto the photosensitive drum 15.

The developer 17 includes a developing roller 17a that is applied a developing bias of a direct-current voltage overlapping with an alternating-current voltage. By the action of the developing bias, the electrostatic latent image formed on the surface of the photosensitive drum 15 is developed with toner. This results in a toner image formed on the surface of the photosensitive drum 15. The toner image is then transferred to the intermediate transfer belt 10. Part of the toner that remains on the photosensitive drum 15, instead of migrating to the intermediate transfer belt 10, is removed by a cleaner 19.

The conveyer path 5 includes a pair of guides 20, and the sheets of paper P accumulated in the feeding cassettes 1 and 2 are sent to the conveyer path 5 on a one-by-one basis by pick-up rollers 21. The conveyer path 5 also includes a pair of timing rollers 23 at a portion that is further downstream than the feeding cassettes 1 and 2 and further upstream than the second-transfer roller 13. The pair of timing rollers 23 ensure accurate synchronization of the forwarding of the sheet of paper P with the toner image on the intermediate transfer belt 10. The sheet of paper P loaded with the toner image that is second-transferred from the intermediate transfer belt 10 is pressed between a fixing roller 25 and a pressure roller 26. The sheet of paper P is then discharged into the collection tray 4 through between discharge rollers 27.

### (2) Main Components

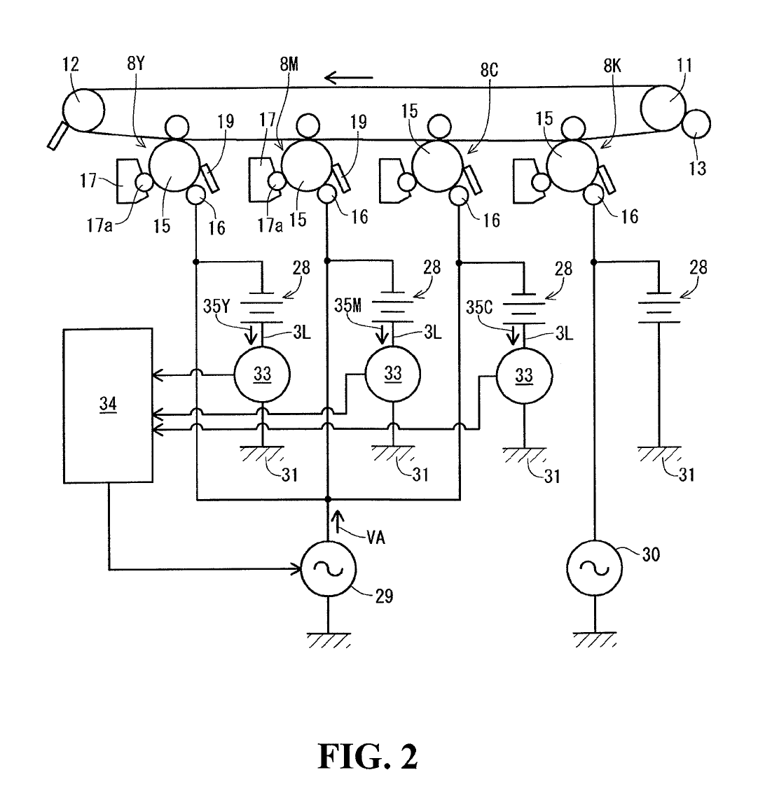

Next, main components of this embodiment will be described by referring to FIG. 2. In this embodiment, the charging roller 16 of each of the image forming units 8Y, 8M, 8C, and 8K is applied a direct-current voltage by a corresponding, individual direct-current power source 28. The charging rollers 16 of the yellow image forming unit 8Y, the magenta image forming unit 8M, and the cyan image forming unit 8C are applied an alternating-current voltage by a common color-purpose alternating-current power source 29. The output of the color-purpose alternating-current power source 29 is adjustable by a transformer, not shown. The black image forming unit 8K is applied an alternating-current voltage by a dedicated alternating-current power source 30 for black purpose. The output of the black-purpose alternating-current power source 30 is adjustable.

Each of the direct-current power sources 28 is wired to earth (frame) 31. For each of the yellow image forming unit 8Y, the magenta image forming unit 8M, and the cyan image forming unit 8C, an ammeter 33, which is an example of the individual direct current sensor, is interposed on a direct-current circuit 32 that couples the direct-current power source 28 to the earth (frame) 31 (a voltmeter may be used instead of the ammeter 33). This ensures sensing (measurement) of the amount of current flowing into the color-purpose direct-current power source 28 when the output of the color-purpose alternating-current power source 29 changes.

The ammeter 33 is coupled to a controller 34 that processes (carries out operations of) a sensed signal of the ammeter 33. The controller 34 sets the output of the color-purpose alternating-current power source 29 based on a result of the processing. The ammeter 33 and the controller 34 may be disposed independently of the image processing unit 3, or more generally, may be incorporated into a regulatory mechanism that controls the printer.

In FIG. 2, for descriptive purposes, the amount of the direct current flowing into the direct-current power source 28 of the yellow image forming unit 8Y is indicated by the arrow 35Y; the amount of the direct current flowing into the direct-current power source 28 of the magenta image forming unit 8M is indicated by the arrow 35M; the amount of the direct current flowing into the direct-current power source 28 of the cyan image forming unit 8C is indicated by the arrow 35C; and the output value of the alternating-current voltage applied from the color-purpose alternating-current power source 29 to the charging rollers 16 of the color-purpose image forming units 8Y, 8M, and 8C is indicated by VA.

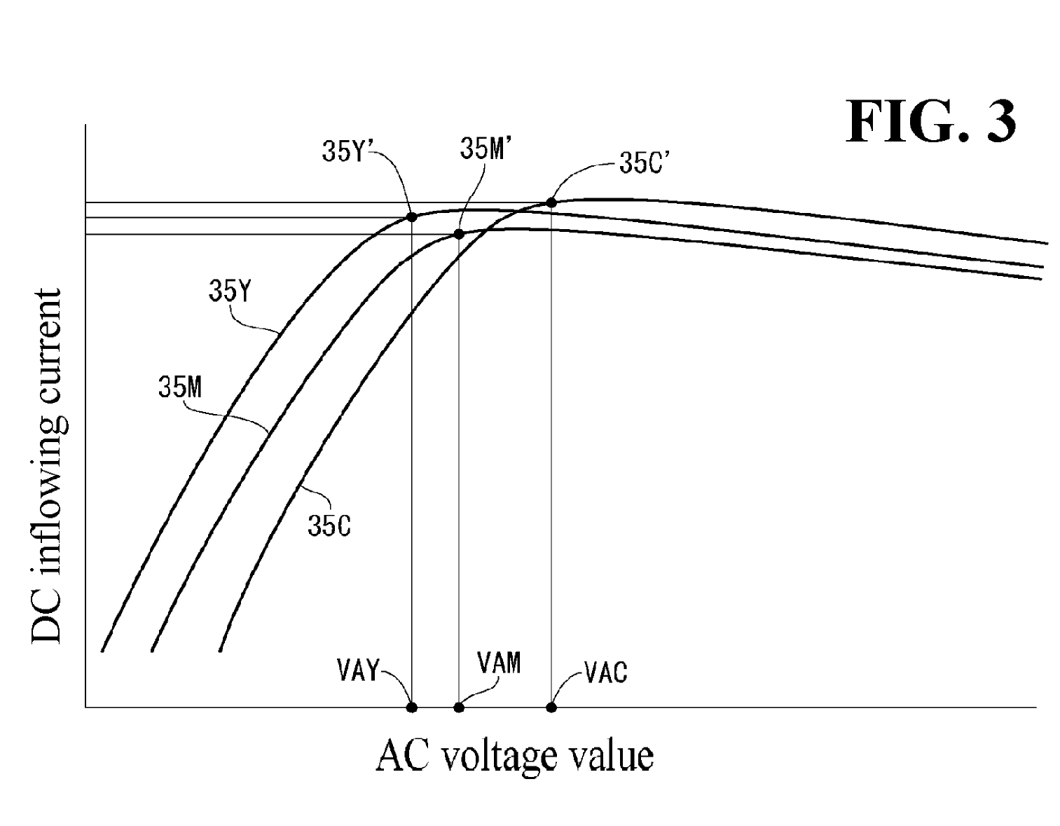

FIG. 3 shows a relationship between the amount of the current and the value of the alternating-current voltage flowing into the direct-current power source 28 of each of the color-purpose image forming units 8Y, 8M, and 8C. FIG. 3 indicates that a saturation area exists where the direct current does not increase even though the alternating-current voltage is applied, that the timing of the saturation varies among the color-purpose image forming units 8Y, 8M, and 8C, and that the color-purpose image forming units have mutually different saturation inflowing current values, namely, 35Y′, 35M′, and 35C′. This is presumably due to difference in electrical properties resulting from different material conditions at the time of production, and due to difference in resistance on the downstream side (on the side of the photosensitive drum 15).

FIG. 3 shows that the saturation inflowing current value 35C′ of the cyan image forming unit 8C is the highest, the saturation inflowing current value 35M′ of the magenta image forming unit 8M is the lowest, and the saturation inflowing current value 35Y′ of the yellow image forming unit 8Y is in the middle. It should be noted, however, that the high-low relationship among the three values and the degree of diversity vary printer by printer.

In this embodiment, the output of the color-purpose alternating-current power source 29 is based on the highest saturation inflowing current value, that is, the value 35C′ of the cyan image forming unit 8C. Specifically, the application output of the color-purpose alternating-current power source 29 is set to ensure that the amount of the inflowing current 35C to the direct-current power source 28 of the cyan image forming unit 8C corresponds to an output VA′ that in turn corresponds to the saturation inflowing current value 35C′. This ensures formation of a high definition image with a minimum current applied to each of the image forming units 8Y, 8M, and 8C.

### (3) Description of the Flowchart

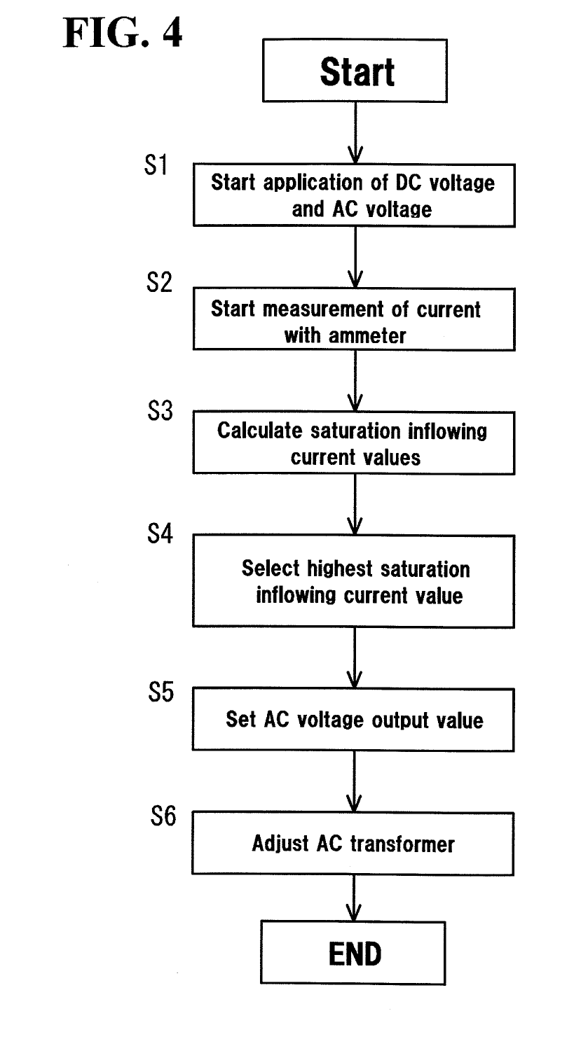

Next, description will be given with respect to the flowchart of FIG. 4, which illustrates the above-described control embodiment. The following description will be only regarding the color-purpose image forming units 8Y, 8M, and 8C, omitting the black image forming unit 8K unless otherwise noted.

First, the main body of the printer is activated. The charging roller 16 of each of the image forming units 8Y, 8M, and 8C is applied a direct-current voltage and an alternating-current voltage respectively by the corresponding direct-current power source 28 and the alternating-current voltage 29 (step S1). Next, the ammeter 33 starts measurement of the inflowing current value (step S2). Then, the controller 34 calculates the saturation inflowing current values 35Y′, 35M′, and 35C′ of the individual direct-current power source circuits 32 (step S3).

The operations for each saturation inflowing current value may include, but not limited to, plotting the current value on a predetermined time basis and calculating (by subtraction) the rate of increase of the current value over the time using a comparator. The current value at which the rate of increase is zero or close to zero may be set as a saturation inflowing current value. That is, the saturation inflowing current value may be set at a value corresponding to a minimal alternating-current voltage in the range of saturation of the inflowing current, as seen in the relationship between the alternating-current voltage and the amount of the inflowing current to the direct-current power source.

After calculation of the three saturation inflowing current values of the three individual direct-current power source circuits 32, the controller 34 selects the highest value of the three values (step S4). The controller 34 then sets the value of an alternating-current voltage corresponding to the selected saturation inflowing current value as a set output of the alternating-current power source 29 (step S5). A memory device stores alternating-current voltage output values as data respectively in pairs with the saturation inflowing current values 35Y′, 35M′, and 35C′. The controller 34 sets the voltage value VAC, which corresponds to the highest saturation inflowing current value 35C′, as the output value of the alternating-current voltage, and controls the transformer to maintain the alternating-current voltage at the set value (step S6).

In the above-described embodiment, a value of alternating-current voltage corresponding to the highest value of the saturation inflowing current values is set as the set output value. Alternatively, a value of alternating-current voltage corresponding to the lowest value may be set as the set output value. This simplifies the operational process while ensuring superior responsiveness. Alternatively, the set output value of the alternating-current voltage may be a highest value of saturation-corresponding alternating-current voltages corresponding to the saturation inflowing current values. In this case, the output value of the alternating-current voltage retains the saturation inflowing current values of the power source circuits irrespective of the relationship of the alternating-current voltage with each of the saturation inflowing current values. This results in improved stability.

The control of the alternating-current power source illustrated in FIG. 4 may be based on the timing of the start of printing (job) instructed through pressing of an operation button, through a signal from an external device (for example, a personal computer), or through some other means. Further, the setting may take place only once for one job. Alternatively, the flow from the current sensing (step S2) to the control of alternating-current voltage (step S6) may be repeated at predetermined time intervals.

Instead of repeating the sensing-setting flow on a predetermined time basis, the controller 34 may continually retrieve data from the ammeter 33, calculate saturation inflowing current values at predetermined time intervals, and change the output of the alternating-current voltage only when a saturation inflowing current value largely deviates from a predetermined value.

While in this embodiment the separate alternating-current power sources 29 and 30 are used respectively for the color-purpose image forming units 8Y, 8M, and 8C and the black image forming unit 8K, a common alternating-current power source may be used to output alternating-current voltage to all the image forming units 8Y, 8M, 8C, and 8K. The toner carrier may be a belt (first-transfer belt) instead of the photosensitive drum.

In the embodiment of the present invention, the controller may be configured to obtain a saturation inflowing current value of each of the plurality of individual direct current sensors based on a result of sensing by a corresponding individual direct-current power source among the plurality of individual direct-current power sources, and configured to set a value of the output of the alternating-current power source based on at least one of a highest saturation inflowing current value and a lowest saturation inflowing current value.

In the embodiment of the present invention, the controller may be configured to obtain a saturation inflowing current value of each of the plurality of individual direct current sensors based on a result of sensing by a corresponding individual direct-current power source among the plurality of individual direct-current power sources, configured to obtain a saturation-corresponding alternating-current voltage corresponding to the saturation inflowing current value, and configured to select, as an output set value, a highest saturation-corresponding alternating-current voltage among a plurality of voltage saturation-corresponding alternating-current voltages obtained.

With the embodiment of the present invention, the amounts of the direct currents flowing into the plurality of individual direct-current power sources are sensed, and the output value of the alternating-current voltage is controlled based on a result of sensing of an amount of a direct current among the direct currents. This ensures reliable control of the alternating-current voltage so that a predetermined amount thereof is applied to each of the charging members, regardless of varied electrical properties caused by production variations and regardless of changes in the amount of current (resistance) flowing through the charging members caused by changes in load.

Specifically, changing the output of the alternating-current voltage changes the values of the direct currents flowing into the respective individual direct-current power sources. In the embodiment of the present invention, however, the amount of a direct current flowing into each of the individual direct-current power sources is sensed to control the output of the alternating-current voltage. This ensures accurate setting of the output value of alternating current necessary for each of the charging members. This also ensures reliable sensing of changes in conditions of the charging members caused by various factors and ensures feedback of the sensed changes to the output control of the alternating-current voltage, resulting in superior real-time performance.

This controls the applied voltage to the charging members at a suitable value, without excess or deficiency, while ensuring an advantageously simplified structure realized by using a common alternating-current voltage source to apply voltage to the plurality of charging members. This ensures high definition and prevents, or significantly reduces, durability degradation of the charging members that is otherwise caused by overcurrent.

In the embodiment of the present invention, the controller may obtain a saturation inflowing current value of each of the plurality of individual direct current sensors based on a result of sensing by a corresponding individual direct-current power source among the plurality of individual direct-current power sources, and may set a value of the output of the alternating-current power source based on at least one of a highest saturation inflowing current value and a lowest saturation inflowing current value. This configuration simplifies the operational process and ensures advantageously superior responsivity.

It is also possible to obtain saturation inflowing current values of each of the plurality of individual direct-current power sources based on results of sensing by the respective individual direct current sensors, obtain saturation-corresponding alternating-current voltages corresponding to the saturation inflowing current values, and select the highest voltage of the saturation-corresponding alternating-current voltages as the set output value. In this case, the output value of the alternating-current voltage retains the saturation inflowing current values of the power source circuits irrespective of the relationship of the alternating-current voltage with each of the saturation inflowing current values. This results in improved stability.

The embodiment of the present invention has industrial applicability especially in, but not limited to, image forming apparatuses of printers and multifunctional machines.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. An image forming apparatus comprising:
a plurality of toner carriers;
a plurality of charging members configured to charge the respective toner carriers;
a common alternating-current power source configured to apply an alternating-current voltage to the plurality of charging members;
a plurality of individual direct-current power sources each configured to apply a direct-current voltage overlapping with the alternating-current voltage to a corresponding charging member among the plurality of charging members;
a plurality of individual direct current sensors each configured to sense an amount of a direct current flowing into a corresponding individual direct-current power source among the plurality of individual direct-current power sources when an output of the alternating-current power source changes; and
a controller configured to set the output of the alternating-current power source based on a result of sensing by an individual direct current sensor among the plurality of individual direct current sensors.

2. The image forming apparatus according to claim 1, wherein the controller is configured to obtain a saturation inflowing current value of each of the plurality of individual direct current sensors based on a result of sensing by a corresponding individual direct-current power source among the plurality of individual direct-current power sources, and is configured to set a value of the output of the alternating-current power source based on a highest saturation inflowing current value.

3. The image forming apparatus according to claim 1, wherein the controller is configured to obtain a saturation inflowing current value of each of the plurality of individual direct current sensors based on a result of sensing by a corresponding individual direct-current power source among the plurality of individual direct-current power sources, and is configured to set a value of the output of the alternating-current power source based on a lowest saturation inflowing current value.

4. The image forming apparatus according to claim 1, wherein the controller is configured to obtain a saturation inflowing current value of each of the plurality of individual direct current sensors based on a result of sensing by a corresponding individual direct-current power source among the plurality of individual direct-current power sources, configured to obtain a saturation-corresponding alternating-current voltage corresponding to the saturation inflowing current value, and configured to select, as an output set value, a highest saturation-corresponding alternating-current voltage among a plurality of voltage saturation-corresponding alternating-current voltages obtained.

5. A method for controlling an image forming apparatus, the method comprising:
applying an alternating-current voltage to a plurality of charging members using a common alternating-current power source, the plurality of charging members being configured to charge respective toner carriers;
applying a direct-current voltage overlapping with the alternating-current voltage to each of the plurality of charging members using a plurality of individual direct-current power sources;
sensing amounts of direct currents flowing into the plurality of individual direct-current power sources; and
setting an output of the alternating-current power source based on a result of sensing of an amount of a direct current among the direct currents.
